(19) United States
(12) Patent Application Publication
(10) Pub. No.: US 2013/0333539 A1
(43) Pub. Date: Dec. 19, 2013

(54) MACHINE FOR CUTTING LEATHERS

(71) Applicant: Gianni Gallucci, Monte Urano (Fermo) (IT)

(72) Inventor: Gianni Gallucci, Monte Urano (Fermo) (IT)

(73) Assignee: TESEO S.p.A., Fermo (IT)

(21) Appl. No.: 14/003,042

(22) PCT Filed: Feb. 20, 2012
(86) PCT No.: PCT/IB12/50764

§ 371 Date: Sep. 4, 2013

(30) Foreign Application Priority Data
Mar. 9, 2011 (IT) BO2011A000112

(51) Int. Cl. C14B 5/00

(52) U.S. Cl. CPC C14B 5/00
USPC 83/155

(57) ABSTRACT

A machine for cutting leathers (1), comprising: a structure (2) which circumscribes an operating area (3) where the leathers are to be laid, maintained stretched and still such as to allow cutting operations; at least an aspirating plane (4, 40) arranged at the operating area (3) and connected to a depression source (9) such as to maintain the leather stretched and still following activation of the depression source (9); a cutting unit (5), borne by the structure (2), arranged above the operating area (3) and movable with respect thereto, such as to realise the cut in the leathers in the operating area (3); the machine (1) comprising at least two closed-loop belts (6, 66) made of a permeable material and flanked to one another, each comprising an upper branch (60, 606) and a lower branch (61, 616), each of the belts (6, 66) being arranged such that the upper branch (60, 606) thereof remains above and in proximity of the aspirating plane (4, 40), in order to restingly receive the leathers to be cut and in order to enable laying of the leathers thereon; the belts (6, 66) being attracted by the aspirating plane (4, 40) following activation of the depression source (9), such that the leathers thereon remain stretched and still; the structure (2) comprising an outlet passage (7) of the leathers, arranged facing the upper branch (60, 606) of each of the belts (6, 66); each belt (6, 66) being activatable, following the completion of the cutting operations thereon, such that the relative upper branch (60, 606) is movable towards the outlet passage (7) in order for the cut leathers to be transferred out of the operating area (3), externally of the structure (2), independently of the other belt (6, 66).

### FIELD OF THE INVENTION

The invention relates to the technical sector of working leathers or the like; in particular, the present invention relates to a machine for cutting leathers.

### DESCRIPTION OF THE PRIOR ART

In the above-mentioned technical sector, a well-known requirement is to maintain the leathers perfectly stretched during the cutting operation, in order to prevent possible creases or wrinkles from altering the desired final shapes of the leather to be obtained.

For this purpose, machines are known for cutting leathers which comprise a structure that surrounds an operating area where the leathers have to be stretched, kept stretched and still and then subjected to the cutting operations.

The machines comprise, at the relative operating area, a fixed aspirating plane made of steel and arranged horizontal, which affords a plurality of through-holes.

The through-holes are connected to a depression source, i.e. a source of aspiration arranged for example below the plane.

The machine further comprises a cutting unit of the automatic type, borne by the structure, arranged above the operating area and mobile with respect thereto. The cutting unit in turn comprises cutting means.

A protection cladding is fixed on the aspirating plane, constituted by a permeable material for example felt, on which the leathers to be cut are stretched.

The felt cladding, being permeable, is such that the leathers stretched thereon are attracted by the depression source and held still during the cutting operations; further, thanks to the relative thickness, the cutting means are prevented from reaching the aspirating plane and damaging it.

The leather stretching operation on the felt is performed by a specialised operator, as specific competences are necessary in order to be able to correctly position the leather with the aim of preventing any folds or wrinkles which might give rise to incorrectly-cut shapes (and therefore to working waste).

The cutting unit is activated following the leather-stretching operation, while keeping the aspirating source active, in order to cut the stretched leathers on the felt, above the aspirating plane, with the aim of obtaining a plurality of different shapes, according to needs.

Once the leather is cut, the cutting unit is halted, the aspirating source is deactivated and the operator has to proceed with the removal of the cut pieces from the work plane, grouping them on the basis of the different profile of the shapes.

Finally the waste cuttings are removed from the work plane and the operator can then newly proceed to stretch the leather on the felt.

These manual-type operations considerably limit productivity and are poorly compatible with the automatic operations with which the cutting of the leathers is carried out. This constitutes, without a doubt, a drawback that is still not obviated in the known-type machines.

In fact, the time the operator requires to collect and sort the shapes of cut leather is much greater than the cutting and stretching times of the leather, as the cut pieces have to be collected one by one and sorted with attention. In other words, the collecting time of the cut pieces constitutes the “bottle-neck” of each working cycle, which significantly limits the productivity of the machine.

A further drawback consists in the fact that the collecting and sorting operation of the cut shapes, while not requiring special competences, is carried out by the same specialised operator who is occupied with the placing of the leather: this means, consequently, high labour costs which in any case would not necessary be indispensable for concluding the above operations.

### SUMMARY OF THE INVENTION

The aim of the present invention is to obviate the above-cited drawbacks.

This aim is attained by providing a machine for cutting leathers according to claim 1, comprising: a structure which circumscribes an operating area where the leathers are to be laid, maintained stretched and still such as to allow cutting operations; at least an aspirating plane arranged at the operating area and connected to a depression source such as to maintain the leather stretched and still following activation of the depression source; a cutting unit, borne by the structure, arranged above the operating area and movable with respect thereto, such as to realise the cut in the leathers in the operating area; the machine comprising: at least two closed-loop belts made of a permeable material and flanked to one another, each comprising an upper branch and a lower branch, each of the belts being arranged such that the upper branch thereof remains above and in proximity of the aspirating plane, in order to restingly receive the leathers to be cut and in order to enable laying of the leathers thereon; the belts being attracted by the aspirating plane following activation of the depression source, such that the leathers thereon remain stretched and still; and in that the structure comprises an outlet passage of the leathers, arranged facing the upper branch of each of the belts; each belt being activatable, following the completion of he cutting operations thereon, such that the relative upper branch is movable towards the outlet passage in order for the cut leathers to be transferred out of the operating area, externally of the structure, independently of the other belt.

The machine for cutting the leathers of the invention advantageously enables, with respect to the prior art, significantly reducing the time passing between two consecutive cutting operations. Once a first stretching of the leathers on one of the belts by a specialised operator has been carried out, the operator can proceed immediately to the stretching of other leathers on the second belt, without having to wait for the cutting operation and the collection of the previously-stretched leathers to conclude.

Further, in this way the collection of the cut shapes can be trusted to a general-type operator, i.e. not the same specialised operator occupied with stretching the leathers: the cut leathers are conveyed by the belts externally of the machine structure. It follows that on the one hand an evident increase in machine productivity obtains, as the down-times of the specialised operator are minimised (and consequently also the downtimes of the general operator whose job is to collect the cut shapes) with respect to known solutions, and on the other hand a considerable saving in terms of total costs of labour is achieved (in relation to machine productivity).

### BRIEF DESCRIPTION OF THE DRAWINGS

The characteristics of the leather-cutting machine of the present invention are set out in the following description, carried out with reference to the accompanying figures of the drawings, in which:

FIG. 1 is a front and perspective view of a preferred but not exclusive embodiment of the leather-cutting machine according to the invention, in which some parts have been removed better to evidence others;

FIG. 2 is a transversal section of the machine of FIG. 1;

FIG. 3 is a rear and perspective view of the preferred embodiment of the realisation of the machine illlustrated in FIG. 1.

### DESCRIPTION OF PREFERRED EMBODIMENTS

With reference to the accompanying figures of the drawings, 1 denotes in its entirety a leather-cutting machine according to the present invention.

The machine 1 comprises: a structure 2 which circumscribes an operating area 3 where the leathers are to be laid, maintained stretched and still such as to allow cutting operations: at least an aspirating plane 4, 40 arranged at the operating area 3 and connected to a depression source 9 such as to maintain the leather stretched and still following activation of the depression source 9.

The machine 1 further comprises: a cutting unit 5, borne by the structure 2, arranged above the operating area 3 and movable with respect thereto, such as to realise the cut in the leathers in the operating area 3 (i.e. the cutting area of the leathers totally coincides with the stretching area thereof).

The machine 1 further comprises at least at least two closed-loop belts 6, 66 made of a permeable material and flanked to one another, each comprising an upper branch 60, 606 and a lower branch 61, 616. In particular, each of the belts 6, 66 being arranged such that the upper branch 60, 606 thereof remains above and in proximity of the aspirating plane 4, 40, in order to restingly receive the leathers to be cut and in order to enable stretching of the leathers thereon.

The belts 6, 66 are attracted by the aspirating plane 4, 40 following activation of the depression source 9, such that the leathers thereon remain stretched and still; further, the structure 2 comprises an outlet passage 7 of the leathers, arranged facing the upper branch 60, 606 of each of the belts 6, 66. In a preferred embodiment, illustrated in the accompanying figures, the belts 6, 66 are two in number.

Each belt 6, 66 is activatable, following completion of the cutting operations thereon, such that the relative upper branch 60, 606 is movable towards the outlet passage 7 In order to transfer the cut leathers out of the operating area 3, externally of the structure 2, independently of the other belt 6, 66. The belts 6, 66 are thus activatable alternately.

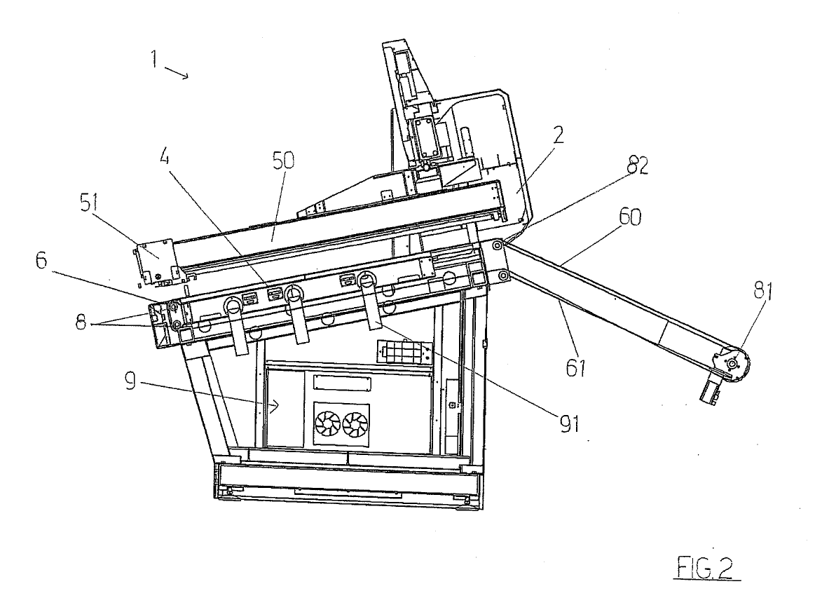

In particular, the aspirating plane 4, 40 is fixed, preferably made of steel and arranged horizontally; the aspirating plane 4, 40 also exhibits a plurality of through-holes (not shown), slaved to the source in depression 9 (indicated generically in FIG. 2), i.e. an aspirating source arranged for example below the aspirating plane 4, 40.

The depression source 9 is connected to the aspirating plane 4, 40 via a series of channels 91, arranged between the lower branch 61, 616 and the upper branch 60, 606 of each belt 6, 66 (see FIG. 2).

In particular only one aspirating plane may be present, in which the aspiration is appropriately sectorized such as to act independently on each of the belts 6, 66, or two aspirating planes 4, 40 may be provided (as in the accompanying figures), one for each of the belts 6, 66.

The cutting unit 5, of the automatic type, comprises an arm 50, mounted on the structure 2 such as to be movable with respect thereto. The arm 50 bears a head 51 which in turn comprises the cutting means and which is movable with respect to the arm 50.

The belts 6, 66 are for example made of felt, so that the leathers lying on them are however attracted by the depression source and held still during the cutting operations. Thanks to the thickness thereof, the belts 6, 66 also prevent the cutting means from reaching the aspirating planes 4, 40 and damaging them.

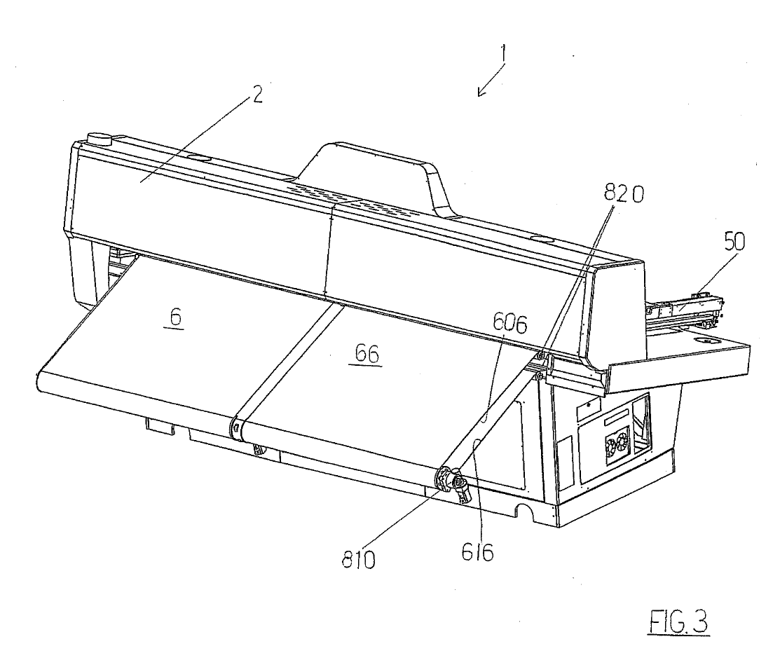

According to a preferred embodiment, represented in the accompanying figures, each belt 6, 66 extends beyond the outlet passage 7, externally to the structure 2, to facilitate the operations of collection of the cut leathers, as will more clearly emerge herein below. In particular, as shown in FIG. 3, the part of each belt 6, 66 which extends beyond the outlet passage 7 is inclined downwards with respect to the aspirating planes 4, 40.

The closed-loop belts 6, 66 are wound on respective rollers: in particular the first end of each belt 6, 66 is wound on a first series of rollers 8, 80 and the second end of each belt 6, 66 is wound on a second series of rollers 81, 810 which allows the movement thereof.

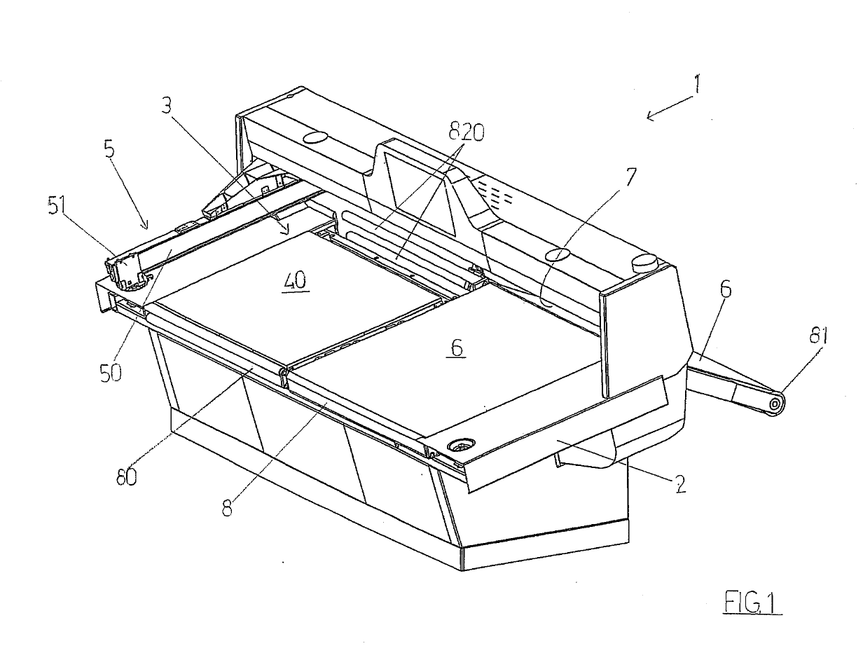

In the above-described preferred embodiment, the first set of rollers 8, 80 around which first end of each tape 6, 66 is wound is arranged at the operating area 3, adjacent to the structure 2, on the opposite side therof with respect to the outlet passage 7; in order to better evidence the arrangement of the first series of rollers 8, 80, in FIG. 1 a part of the structure 2 has been removed.

The second series of rollers 81, 810 is instead arranged over the outlet passage 7, where the inclined portion of each belt 6, 66 reaches the lowest point with respect to the aspirating planes 4, 40 (see in particular FIGS. 1 and 2) .

A third series of return rollers 82, 820 may also be provided, for example arranged for at the outlet passage 7 to support the belts 6, 66 and to enable the downward inclination thereof.

Alternatively, in a variation that is not illustrated, a plane can be present, arranged externally of the structure, in place of the inclined portion of the belts, so as to receive the cut leather following the movement of the belts towards the outlet passage. The plane is for example inclined downwards with respect to the aspirating planes and can therefore be a chute.

In the last above-described case the second series of rollers around which the belts are wound may be arranged at the outlet passage, so that the inclined plane has a side arranged facing and adjacent to the second end of the belts. Two inclined planes can be provided, one for each belt.

By way of clarification, the operation of the machine 1 will now be described during a respective first operating cycle, from the stretching of the leathers to the cutting thereof into shapes of the desired profile, with particular reference to the embodiment referred to in the accompanying figures. For the sake of simplicity the two belts 6, 66 will be referred to in the following as the first belt 6 and the second belt 66; at the beginning of the first operating cycle the two belts 6, 66 of the machine 1 are both deactivated.

Firstly, a specialist operator stretches the leathers in the operating area 3 (the specialist operator is thus arranged frontally of the machine 1), on the upper branch 60 of the first belt 6, which is felt and which remains stationary. The operation of stretching the leather requires special expertise, as it is necessary to prevent possible creasing or wrinkling which might distort the desired leather shapes and produce waste.

Once the leathers have been stretched, the depression source 9 is activated at the position of the first conveyor 6 (which is still disabled, as is the second belt 66), so that the leathers remain stretched and still.

Then, the cutting unit 5 can be activated: the cutting head 51 moves such as to achieve the predefined shapes using the relative cutting means on leathers stretched on the first belt 6.

Simultaneously, the specialist operator can proceed to stretch the leathers on the upper branch 606 of the second belt 66, which remains stationary. The depression source 9 is then activated such as to act on the second belt 66, such that the leathers stretched thereon remain stretched and still.

When the shapes of the skin on the first belt 6 have been cut, the cutting head 5 is deactivated and the depression source 9 turned off at the first belt 6.

The cutting unit 5 can then be brought to work on the leathers lying on the second belt 66, while the first belt 6 can be activated to transfer, via its upper branch 60, the cut leathers from the operating area 3 towards the outlet passage 7 and beyond the passage 7; once the leathers have been transferred externally to the structure 2, the first belt 6 is stopped.

Then a general operator, positioned to work outside the structure 2 (in particular arranged posteriorly of the machine 1), can easily proceed to collect the cut leather shapes arranged on the first belt 6, collecting them from the inclined portion thereof, and grouping them on the basis of their profile shapes.

At the same time, once leathers previously stretched on the second belt 66 have been cut, the cutting head 51 is stopped and the depression source 9 deactivated: the second belt 66 can be activated to move the cut leathers towards the passage 7 and beyond it, externally of the structure 2, so that the general operator can collect them (after stopping the second belt 66).

Meanwhile, the skilled operator can newly stretch further leathers in the operating area 3, on the upper branch 60 of the first belt 6; the operating cycle is then repeated.

According to a variant that is not illustrated, the leathers stretched on the second belt can be conveyed to a further outlet passage, different to the outlet passage described above.

In another variant, also not illustrated, more than two closed-loop belts may be present, as well as more than two aspirating planes.

The above has been described by way of non-limiting example, and any constructional variants are understood to fall within the ambit of the following claims.

1. A machine for cutting leathers, comprising:
a structure which circumscribes an operating area where the leathers are to be laid, maintained stretched and still such as to allow cutting operations:
at least an aspirating plane arranged at the operating area and connected to a depression source such as to maintain the leather stretched and still following activation of the depression source;
a cutting unit, borne by the structure, arranged above the operating area and movable with respect thereto, such as to realize the cut in the leathers in the operating area;
at least two closed-loop belts made of a permeable material and flanked to one another, each comprising an upper branch and a lower branch, each of the belts being arranged such that the upper branch thereof remains above and in proximity of the aspirating plane, in order to restingly receive the leathers to be cut and in order to enable laying of the leathers thereon; the belts being attracted by the aspirating plane following activation of the depression source, such that the leathers thereon remain stretched and still;
and in that the structure comprises an outlet passage 0 of the leathers, arranged facing the upper branch of each of the belts;
each belt being activatable, following the completion of the cutting operations thereon, such that the relative upper branch is movable towards the outlet passage in order for the cut leathers to be transferred out of the operating area, externally of the structure, independently of the other belt .

2. The machine of claim 1, wherein the belts extend beyond the outlet passage, externally of the structure, such as to facilitate the collecting operations of the cut leathers.

3. The machine of claim 2, wherein the part of each belt which extends beyond the outlet passage is inclined downwards with respect to the aspirating plane.

4. The machine of claim 1, further comprising at least a plane arranged externally of the structure, at the outlet passage, for receiving the cut leathers.

5. The machine of claim 4, wherein the plane is inclined downwards with respect to the aspirating plane.
